(19) United States
(12) Patent Application Publication
(10) Pub. No.: US 2007/0115415 A1
(43) Pub. Date: May 24, 2007

(54) Light absorbers and methods

(76) Inventors: Arthur Piehl, Corvallis, OR (US); Michael G. Monroe, Corvallis, OR (US); Conor Kelly, Corvallis, OR (US); John R. Sterner, Corvallis, OR (US); James C. McKinnell, Corvallis, OR (US); James R. Przybyla, Corvallis, OR (US); John L. Williams, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/284,225

(22) Filed: Nov. 21, 2005

(51) Int. Cl. G02F 1/1335

(52) U.S. Cl. 349/137

(57) ABSTRACT

For one embodiment, a reflection is reduced to substantially zero regardless of a wavelength of incident light that produced the reflection.

### BACKGROUND

Digital projectors often include micro-displays that include arrays of pixels. Each pixel may include a liquid crystal on silicon (LCOS) device, an interference-based modulator, etc. A micro-display is used with a light source and projection lens of the digital projector, where the projection lens images and magnifies the micro-display. The micro-display receives light from the light source. When the pixels of the micro-display are ON, the pixels direct the light to the projection lens. When the pixels are OFF, they produce a “black” state. The quality of black state determines a projector's black/white contrast ratio that is often defined as the ratio of the light imaged by the projection lens when all of the pixels in the micro-display are ON to the light imaged by the projection lens when all of the pixels are OFF and is a measure of the “blackness” of the projector's black state.

Some interference-based modulators, such as Fabry-Perot modulators, include a total reflector and a partial reflector separated by a gap, such as an air-containing gap, that can be adjusted by moving the total and partial reflectors relative to each other. The black state is produced when the air gap is adjusted to produce constructive interference of light beams passing through the absorptive partial reflector. The intensity of the light can vary greatly within different materials due to absorption and interference effects. One such interference effect that can occur within a thin film stack is referred to as electric field enhancement. It occurs when phase shifts from reflections within the stack add linearly to increase the electric field amplitude and thus increase the localized intensity in the layer. This yields maximum absorbance of the incident light and thus optimal black state. In the light state, the phase shifts are not constructive in the partial reflecting layer thus more energy escapes the cavity. Residual reflections may still occur because of design and material limitations, with the amount of residual reflection depending on the wavelength of the light incident on the modulator. This can cause problems, especially for multi-colored modulators, where the wavelength of incident light varies according to its color.

The absorption of incident radiation (or alternatively extinction of the electric field) by the partial reflector determines the maximum allowable thickness of the layer. Effectively the greater the absorption, the less light enters and escapes the SFX device and thus the modulator acts more like a mirror than a tunable modulator. At high thicknesses (greater than skin depth), the radiation is unaffected by the Fabry Perot cavity (air gap), and the reflected spectra is the native reflectance of the partial reflector. At low thicknesses, (i.e. less than skin depth) the device tunes color states well, but a poor black state results. At proper thicknesses, the device maintains wavelength tunability with the ability to absorb the bulk of the incident light in the black state.

### DESCRIPTION OF THE DRAWINGS

FIG. 1 is a cross-sectional view of a portion of an embodiment of a micro-display display with compensation, according to an embodiment of the invention.

FIG. 2 is a cross-sectional view of an embodiment of a filter, according to another embodiment of the invention.

FIG. 3 presents results of a computer simulation of an exemplary embodiment of the invention.

FIG. 4 is a cross-sectional view of another embodiment of a filter, according to another embodiment of the invention.

FIG. 5 is a cross-sectional view of another embodiment of a filter, according to another embodiment of the invention.

FIG. 6 is a cross-sectional view of another embodiment of a micro-display, according to another embodiment of the invention.

FIGS. 7A-7C are reflection diagrams (of prior art?) without compensation.

FIGS. 8A-8C are reflection diagrams with compensation, according to another embodiment of the invention.

FIGS. 9A-9B are reflection diagrams, according to another embodiment of the invention.

FIG. 10 is a cross-sectional view of a portion of an embodiment of a micro-display display without compensation.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

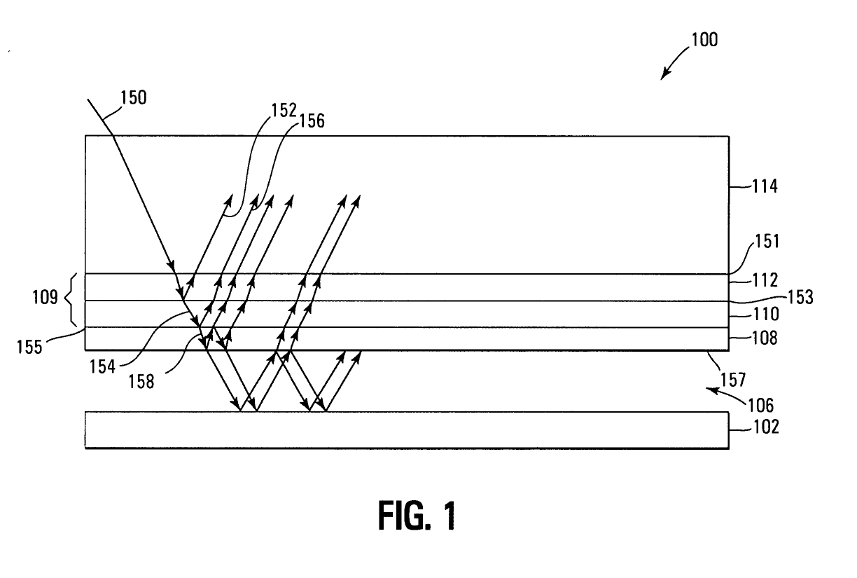

FIG. 1 is a cross-sectional view of a portion of a micro-display 100, e.g., as a portion of a digital projector, according to an embodiment. For one embodiment, the micro-display is a modulator, such as an interference-based modulator, of the digital projector.

Micro display 100 includes a total reflector (or micro-mirror) 102 that may be formed overlying a semiconductor substrate, e.g., of silicon or the like. Total reflector 102 may be directly mounted on the substrate or be movable with respect to the substrate. For one embodiment, total reflector 102 is a pixel of a pixel array of micro-display 100. A gap 106, e.g., filled with a gas, such as air or an inert gas (argon, etc.), separates total reflector 102 from a partially reflective layer 108, e.g., a tantalum aluminum (TaAl) layer. Alternatively, gap 106 may contain a vacuum. A compensator 109 is formed overlying partially reflective layer 108. For one embodiment, compensator 109 includes a compensator layer 110, e.g., a dielectric layer, such as an oxide layer (e.g., a silicon dioxide (SiO₂) layer) formed on partially reflective layer 108. Compensator 109 also includes a compensator layer 112, e.g., a dielectric layer, such as a nitride (e.g., a silicon nitride (SiN) layer) or a carbide layer formed on the compensator layer 110. For a further embodiment, compensator layer 112 may be a partially reflective layer, such as a partially reflecting metal, e.g., of tantalum aluminum (TaAl). For one embodiment, compensator layer 112 is a high-index-of-refraction layer and compensator layer 110 a low-index-of-refraction layer. For example, compensator layer 110 may have an index of refraction of about 1.46, whereas compensator layer 112 may have an index of refraction of about 2.02. For another embodiment, partially reflective layer 108 has a non-zero extinction coefficient, for example a complex index of refraction of about 2.96-2.65i. For some embodiments, a transparent stiffening layer 114, e.g., of TEOS (tetraethylorthosilicate) oxide, silicon oxide, etc., is formed on compensation layer 112. For one embodiment, transparent stiffening layer 114 has substantially the same index of refraction as compensator layer 110.

For one embodiment, total reflector 102 is movable relative to partially reflective layer 108 (e.g., may be mounted on flexures as is known in the art) for adjusting the size of gap 106. Alternatively, for another embodiment, the size of gap 106 may be adjusted by moving transparent stiffening layer 114 and the layers attached thereto while total reflector 102 is stationary. In another embodiment, the partially reflecting layer 108 is mounted on a transparent substrate (not shown) that is illuminated from one side. The partially reflective layer 108 and total reflector 102 are defined on the opposite side of the transparent substrate. Gap 106 is adjusted by moving the total reflector 102 relative to partially reflective layer 108.

The arrows of FIG. 1 illustrate light paths, according to an embodiment, in response to micro-display 100 receiving incident light 150 from a light source located exteriorly of micro-display 100, such as a laser, light emitting diode (LED), a high-pressure mercury light source, etc., and such light may pass through a multi-colored color wheel. Incident light 150 passes through transparent stiffening layer (or incidence layer) 114, is refracted at an interface 151 between transparent stiffening layer 114 and compensator layer 112, and passes through compensator layer 112. A portion 152 of the refracted light is reflected off an interface 153 between compensator layer 112 and compensator layer 110, passes back through compensator layer 112, is refracted at interface 151, and passes through transparent stiffening layer 114. A portion 154 of the refracted light is refracted at interface 153 and passes through compensator layer 110. A portion 156 of refracted light portion 154 is reflected off an interface 155 between compensator layer 110 and partially reflective layer 108, passes back through compensator layer 110, is refracted at interface 153, passes through compensator layer 112, is refracted at interface 151, and passes through transparent stiffening layer 114. A portion 158 of refracted light portion 154 is refracted at interface 155 and passes through partially reflective layer 108.

Note that a portion of each reflection from total reflective layer 102 to partially reflective layer 108 is reflected to produce multiple reflections between total reflective layer 102 and partially reflective layer 108 as just described above. Another portion of each reflection from total reflective layer 102 to partially reflective layer 108 is transmitted through partially reflective layer 108, compensator layer 110, compensator layer 112, and transparent stiffening layer 114, as just described above.

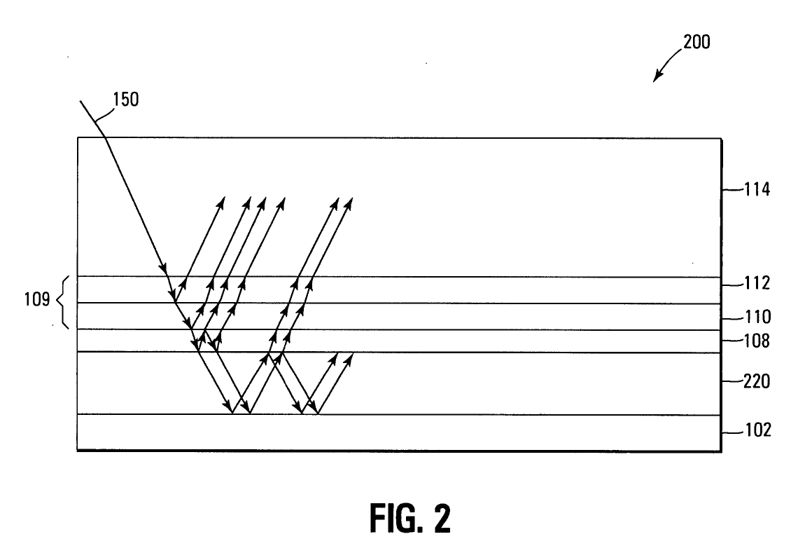

FIG. 2 is a cross-sectional view of a light-absorbing, anti reflective stack (or filter) 200, used for instance as a shadow mask or hide layer to absorb unwanted incident light 150 on micro display 100, according to another embodiment used for instance as a shadow mask or hide layer to absorb unwanted incident light 150 on micro display 100. Common reference numbers in FIGS. 1 and 2 denote similar (or analogous) elements. Note that a dielectric layer 220, such as silicon dioxide, replaces gap 106 of FIG. 1. A comparison of FIGS. 1 and 2 indicates that the light paths through micro display 100 and light-absorbing, anti reflective stack 200 in response to light 150 are similar. More specifically, gap 106 of FIG. 1, containing a dielectric material, e.g., air, and dielectric layer 220 of FIG. 2 are analogous. Therefore, compensation layers 110 and 112 of light-absorbing, anti reflective stack 200 have substantially the same compensating effect as in the structure of FIG. 1. That is, the reflectance of light-absorbing, anti reflective stack 200 is substantially independent of the wavelength of incident light 150 and that compensation layers 110 and 112 can be selected to compensate for different thicknesses of partially reflective layer 108, as discussed below.

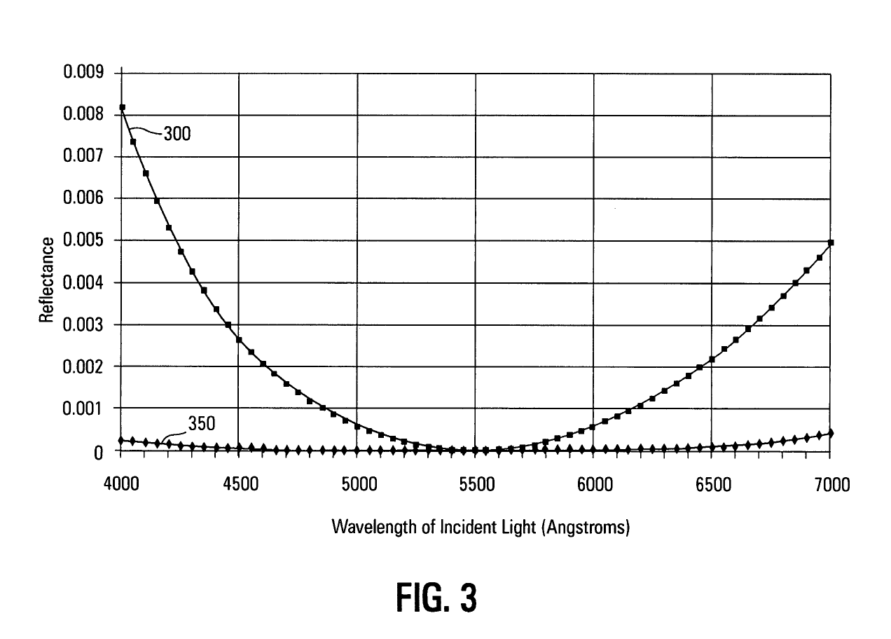

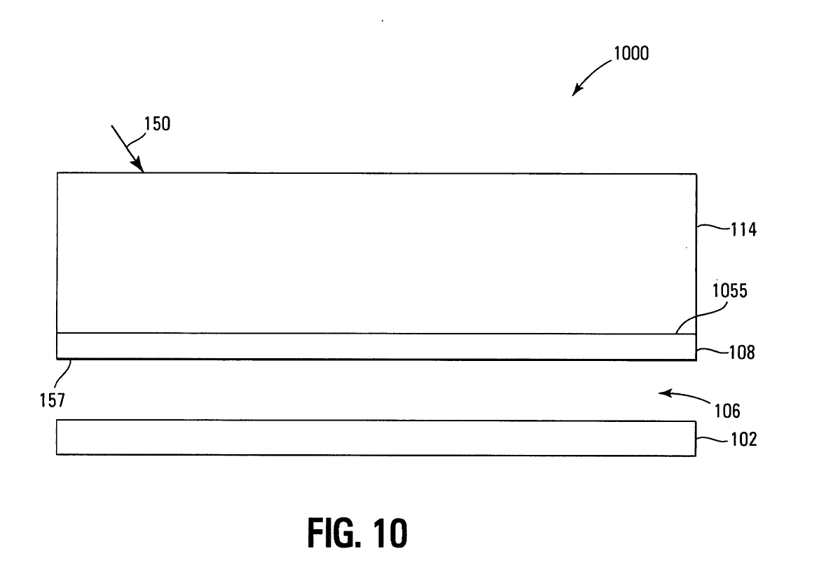

FIG. 3 presents the results of a computer simulation of an exemplary embodiment. Plot 300 shows the reflectance for a micro-display 1000 of FIG. 10. Common numbering in FIGS. 1 and 10 denotes similar elements. Note that Micro-display 1000 does not include compensator 109. Plot 350 shows the reflectance for micro-display 100 of FIG. 1. Therefore, FIG. 3 compares the effect of compensator 109 on the reflectance. The results of FIG. 3 correspond to micro-displays 100 and 1000 being in an OFF state or black state, obtained by adjusting gap 106. Plot 300 shows the reflectance for a total reflector, e.g., that corresponds to a total reflector 102 of FIG. 10, a partially reflective layer of 79 angstroms, e.g., that corresponds to partially reflective layer 108 of FIG. 10, and an air gap of 1010 angstroms, e.g., that corresponds to gap 106 of FIG. 10 without compensator 109, interposed between the total reflector and the partially reflective layer. Plot 350 shows the reflectance for a total reflector, e.g., that corresponds to a total reflector 102 of FIG. 1, a partially reflective layer of 94 angstroms, e.g., that corresponds to partially reflective layer 108 of FIG. 1, an air gap of 960 angstroms, e.g., that corresponds to gap 106 of FIG. 1, interposed between the total reflector and the partially reflective layer, a silicon dioxide (SiO₂) layer of 300 angstroms and an index of refraction of about 1.46, e.g., that corresponds to compensator layer 110 of FIG. 1, on the partially reflective layer, and a silicon nitride (SiN) of 126 angstroms and an index of refraction of about 2.00, e.g., that corresponds to compensator layer 112 of FIG. 1, on the silicon dioxide layer.

In FIG. 3, note that, for plot 300, the reflectance is the reflectance at an upper surface 1055 of partially reflective layer 108 (FIG. 10), whereas for plot 350 the reflectance is the reflectance at interface 151 of FIG. 1 or at an upper surface of compensator layer 112. Therefore, a comparison of plots 300 and 350 illustrates the effect of compensator layers 110 and 112, and thus compensator 109, on the reflectance in the black state.

In FIG. 3, note that for plot 350, the presence of the silicon dioxide layer (compensator layer 110) and the silicon nitride layer (compensator layer 112) for this exemplary embodiment acts to reduce the dependence of the reflectance on the wavelength of the incident light, e.g., corresponding to incident light 150 on micro-display 100, so that it is essentially independent of the wavelength of the incident light. This means that compensator layers 110 and 112 compensate for the effect of wavelength of incident light on the reflectance (or the black state). Therefore, the black state is essentially independent of the color of the incident light on display 100.

At wavelengths between about 5300 to about 5600 angstroms (FIG. 3), the reflectance at interface 1055 (FIG. 10) is substantially the same as at interface 151 (FIG. 1). Note that partially reflective layer 108 for plot 300 is 79 angstroms and is 94 angstroms for plot 350. From a manufacturing standpoint, if a design (or desired) thickness of partially reflective layer 108 is 79 angstroms and partially reflective layer 108 is manufactured to have a thickness (an actual thickness) of 94 angstroms, it is clear that the reflectance at the upper surface of the 94-angstrom layer will be different than the desired reflectance at the upper surface of the 79-angstrom layer. Therefore, plot 350 shows that compensation layer 109 can be adjusted, by adjusting the thicknesses of compensator layers 110 and/or 112, to compensate for the difference in reflectance due to the error in the thickness of partially reflective layer 108 between the desired and actual thickness. Therefore, during manufacturing, partially reflective layer 108 can be measured after it is formed and compensator layers 110 and/or 112 can be adjusted to give a desired reflectance. A comparison of FIGS. 1 and 2 reveals that the compensation layers 110 and 112 of light-absorbing, anti reflective stack 200 can be selected to compensate for different thicknesses of partially reflective layer 108 of light-absorbing, anti reflective stack 200.

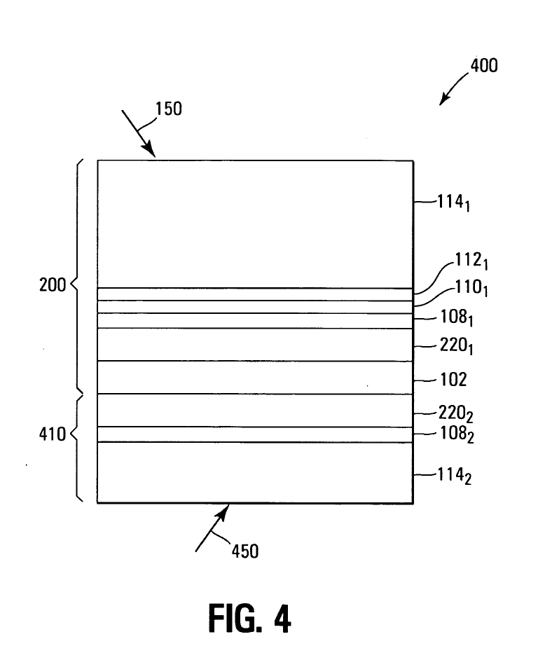

FIG. 4 is a cross-sectional view of a light-absorbing, anti reflective stack (or filter) 400, such as a hide layer, that may be a portion of micro-display 100, according to another embodiment. Common reference numbers in FIGS. 2 and 4 denote analogous elements. For one embodiment, light-absorbing, anti reflective stack 400 includes light-absorbing, anti reflective stack 200 and an light-absorbing, anti reflective stack 410 that is formed below light-absorbing, anti reflective stack 200. For one embodiment, light-absorbing, anti reflective stack 410 includes dielectric layer 220₂ formed on total reflective layer 102 and partial reflecting layer 108₂ formed on dielectric layer 220₂. For another embodiment, transparent stiffening layer (or incidence layer) 114₂ may be formed on partial reflecting layer 108₂. Light-absorbing, anti reflective stack 200 performs as described above in conjunction with FIG. 2 in response to receiving light 150 at transparent stiffening layer 114₁. Light-absorbing, anti reflective stack 410, receives light 450, e.g., reflected light, such as from interior components of a micro-display, from below. Light-absorbing, anti reflective stack 410 acts to reduce or prevent light 450 from being reflected off total reflective layer 102 that would otherwise occur in the absence of light-absorbing, anti reflective stack 410. Therefore, light-absorbing, anti reflective stack 400 acts to produce black states from above and below. This is discussed further below.

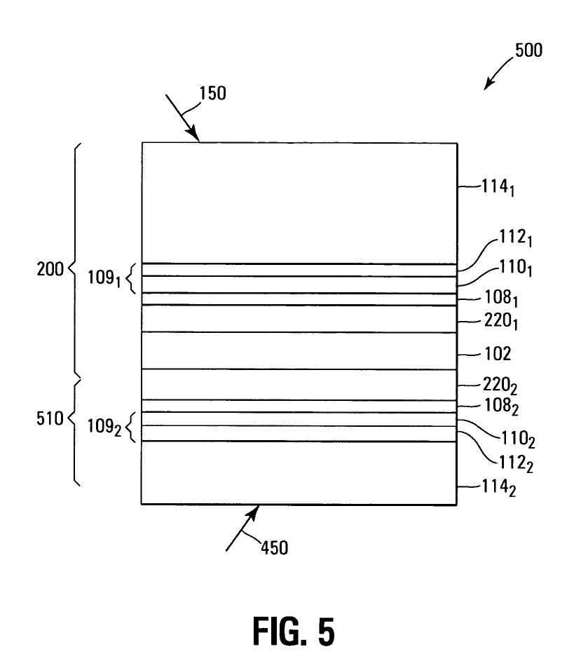

FIG. 5 is a cross-sectional view of a light-absorbing, anti reflective stack (or filter) 500, such as a hide layer, that may be a portion of micro-display 100, according to another embodiment. Common reference numbers in FIGS. 2, 4, and 5 denote analogous elements. For one embodiment, light-absorbing, anti reflective stack 500 includes light-absorbing, anti reflective stack 200 and a light-absorbing, anti reflective stack 510 that is formed below light-absorbing, anti reflective stack 200. For one embodiment, light-absorbing, anti reflective stack 510 includes dielectric layer 220₂ formed on total reflective layer 102 and partial reflecting layer 108₂ formed on dielectric layer 220₂. Compensator 109₂ is formed underlying partial reflecting layer 108₂, and includes compensator layer 110₂ formed on partial reflecting layer 108₂ and compensator layer 112₂ formed on compensator layer 110₂. Note that compensators 109 are disposed symmetrically about total reflective layer 102 for one embodiment. For another embodiment, transparent stiffening layer (or incidence layer) 114₂ may be formed on compensator layer 112₂. Light-absorbing, anti reflective stack 200 performs as described above in conjunction with FIG. 2 in response to receiving light 150 at transparent stiffening layer 114₁. Light-absorbing, anti reflective stack 510, receives light 450. Light-absorbing, anti reflective stack 510 acts to reduce or prevent light 450 from being reflected off total reflective layer 102 that would otherwise occur in the absence of light-absorbing, anti reflective stack 510. Therefore, light-absorbing, anti reflective stack 500 acts to produce black states from above and below. This is discussed further below. Also note that light-absorbing, anti reflective stack 510 together with total reflective layer 102 performs as described above in conjunction with light-absorbing, anti reflective stack 200. Other combinations of opposed hide layers with and without compensator layers are also possible and considered disclosed herein.

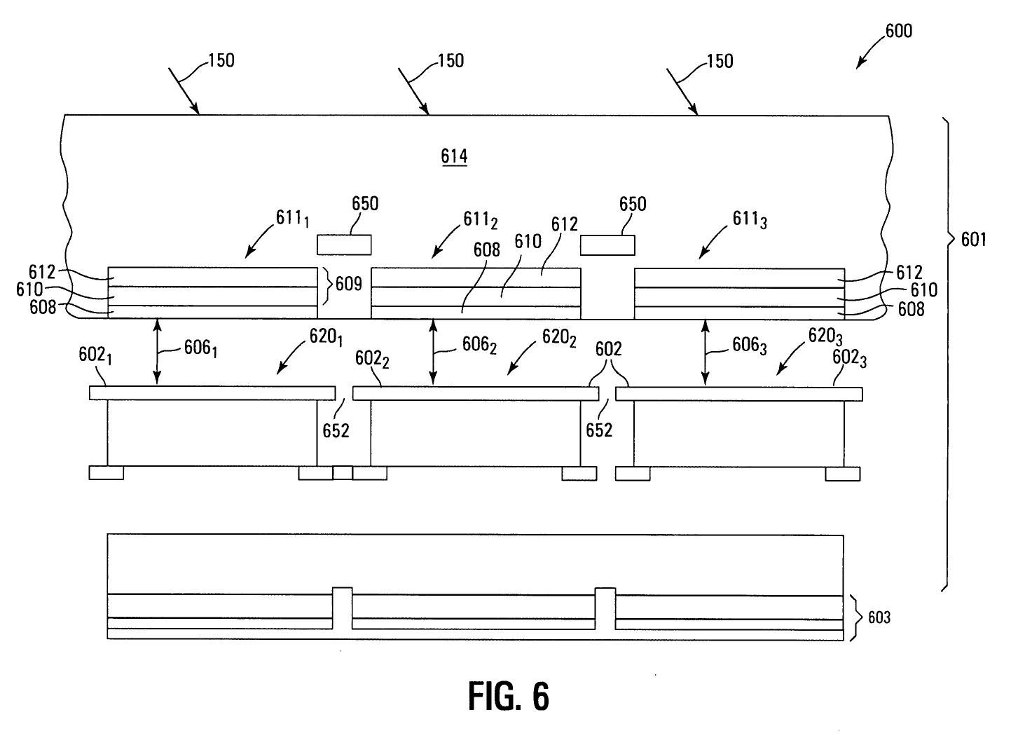

FIG. 6 is a cross-sectional view of a micro-display 600, e.g., as a portion of a digital projector, according to another embodiment. For one embodiment, micro-display 600 functions as a light modulator of the digital projector. For another embodiment, micro-display 600 includes a device 601 and a driver 603. For some embodiments, device 601 includes one or more micro-electromechanical system (MEMS) devices 620, such as micro-mirrors, liquid crystal on silicon (LCOS) devices, interference-based modulators, etc., that correspond to pixels.

For one embodiment, device 601 includes pixel plates 602 as a portion of the MEMS devices 620. Each of pixel plates 602 is analogous to total reflector (or micro-mirror) 102 of FIG. 1. For one embodiment, each of pixel plates 602 is suspended by flexures as is known in the art. Each of gaps 606 is analogous to gap 102 of FIG. 1 and separates a respective one of pixel plates 602 from a stack 611 having a partially reflecting layer 608 analogous to partially reflecting layer 108 of FIG. 1. Stack 611 includes a compensator 609 that is analogous to compensator 109 of FIG. 1 and is formed overlying partially reflective layer 608. For one embodiment, compensator 609 includes a compensator layer 610 that is formed on partially reflective layer 608 and that is analogous to compensator layer 110 of FIG. 1. Compensator 609 also includes a compensator layer 612 that is formed on compensator layer 610 and that is analogous to compensator layer 112 of FIG. 1. A transparent stiffening layer 614 that is analogous to transparent stiffening layer 114 of FIG. 1 is formed on compensator layer 612 of each of the stacks 611.

For one embodiment, driver 603 is a Complementary Metal Oxide Semiconductor (CMOS) substrate. Driver 603 can be formed using semiconductor-processing methods known to those skilled in the art. Driver 603 includes driver circuits adapted to respectively control the positions of pixel plates 602, and thus the corresponding gaps 606, to turn pixels corresponding to pixel plates 602 ON or OFF.

Note that pixel plate 602, the corresponding gap 606, partially reflecting layer 608, compensator 609, and transparent stiffening layer 614 form a structure analogous to the portion of micro-display 100 of FIG. 1. Therefore, the structure of FIG. 6 performs substantially the same way as described above for the analogous structure of FIG. 1. That is, the black state produced when the pixels of micro-display 600 are OFF is essentially independent of the color of the incident light on micro-display 600. Moreover, compensation layers 610 and 612 can be selected to compensate for different thicknesses of partially reflective layer 608.

For one embodiment, light-absorbing, anti reflective stacks 650 are formed directly above gaps 652 that separate adjacent pixel plates 602 and portions of adjacent pixel plates 602 that are adjacent to a gap 652. For another embodiment, light-absorbing, anti reflective stacks 650 are formed on a portion of stiffening layer 614 located between adjacent stacks 611. Note for other embodiments, another portion of stiffening layer 614 overlies light-absorbing, anti reflective stacks 650. For another embodiment, light-absorbing, anti reflective stacks 650 are analogous to light-absorbing, anti reflective stacks 200, 400, or 500, respectively of FIGS. 2, 4, and 5. When analogous to absorbing stacks 200, light-absorbing, anti reflective stacks 650 act to reduce reflections due to incoming incident light 150, as described in conjunction with FIG. 2, and thus act to produce a black state from above. In some instances, there may be internal reflections off pixel plates 602, e.g., corresponding to light 450 of FIGS. 5 and 6, that may be reflected back to the pixel plates 602 when using light-absorbing, anti reflective stacks 650 analogous to light-absorbing, anti reflective stack 200, e.g., off total reflective layer 102 (FIG. 2), that may pass through gaps 652 and into driver 603. Therefore, it is advantageous, for some embodiments, to use a light-absorbing, anti reflective stacks 650 analogous to light-absorbing, anti reflective stacks 400 or 500 that act to produce black states above and below and that act to reduce light from being reflected back to the pixel plates 602. For another embodiment, posts may be formed between successive pixel plates or groups of pixel plates as is known in the art. For these embodiments, a light-absorbing, anti reflective stack 650 may be placed over each of the posts.

Note that micro-display 600 need not have gaps 606, such as a Fabry-Perot micro-display for the light-absorbing, anti reflective stacks 650 analogous to light-absorbing, anti reflective stacks 200, 400 or 500 to be effective and beneficial. Rather, anti reflective stacks 650 can be used with any micro-display having a plurality of pixels that modify color, output directionality, polarity or other characteristic of incoming light. For example, each pixel may include a liquid crystal on silicon (LCOS) device.

Electric field enhancement caused by phase shifts upon reflection from partially reflective layer 108 of FIG. 1 and total reflector 102 and proper sizing of gap 106 contribute to the achievement of the black state. The black state occurs when these phase shifts add constructively to yield maximum field amplitude in the absorbing partially reflective layer 108. Because partially reflective layer 108 absorbs proportional to the intensity, it absorbs the majority of the power in gap 106 yielding little light escaping from the device. In the light ON state the phase shifts do not add constructively (because the size of gap 106) and less total light is absorbed in partially reflective layer 108, allowing light to escape from the device.

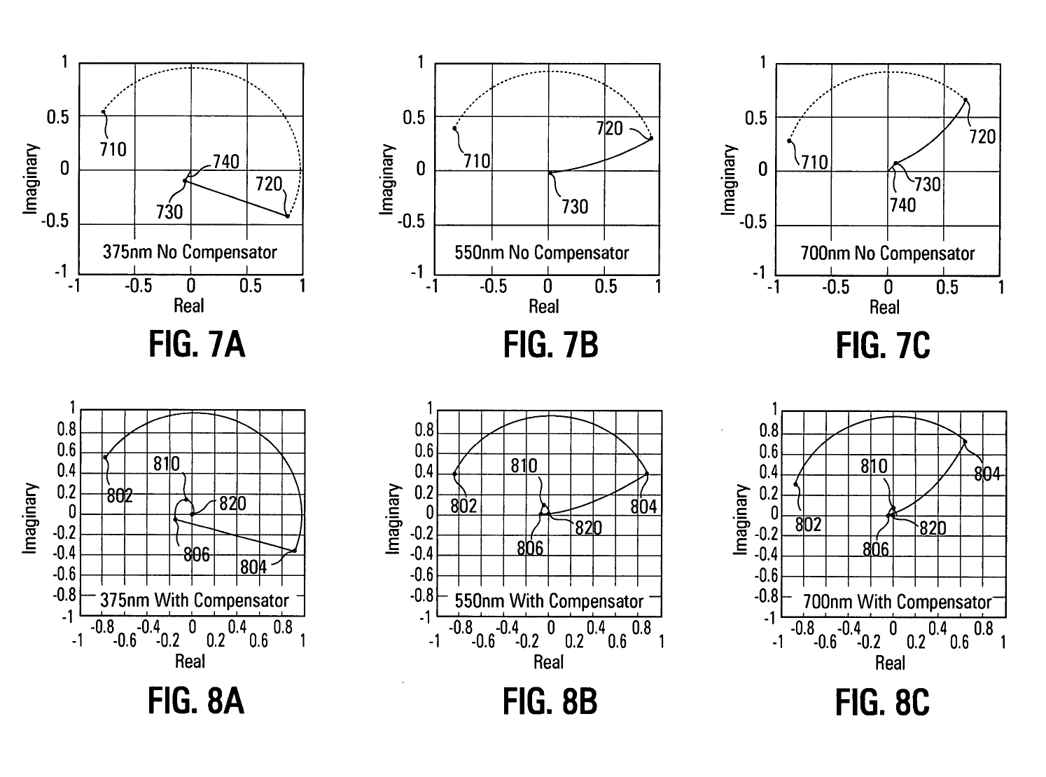

FIGS. 7A-7C are reflection diagrams, e.g., for micro-display 1000 of FIG. 10 respectively at different wavelengths, e.g. substantially spanning visible spectrum of about 380 nm to about 700 nm, of incident light 150. FIGS. 7A-7C have common vertical axes that correspond to the imaginary part of the amplitude reflection coefficient as the film is grown, as shown in FIG. 7A, and horizontal axes that correspond to the real part of the amplitude reflection coefficient as the film is grown. FIGS. 8A-8C are reflection diagrams, according to another embodiment, e.g., for micro-display 100 of FIG. 1 respectively at different wavelengths of incident light 150. FIGS. 8A-8C have common vertical axes that correspond to the imaginary part of the amplitude reflection coefficient as the film is grown, as shown in FIG. 8A, and horizontal axes that correspond to the real part of the amplitude reflection coefficient as the film is grown.

In FIGS. 7A-7C, point 710 corresponds to the surface of total reflector 102, and point 720 corresponds to a lower surface 157 of partially reflective layer 108 adjacent an interface between gap 106 and partially reflective layer 108 (FIG. 10). Point 730 corresponds to upper surface 1055 partially reflective layer 108 (FIG. 10) and denotes the end of the stack to which FIGS. 7A-7C correspond. The point of no reflection (i.e., the ideal black state) is located at the origin (0,0) of the respective diagrams of FIGS. 7A-7C. The intensity of reflection at points 710, 720, and 730 is given by the complex electric field (E) times its complex conjugate (E*), which is respectively represented by the distance between 710, 720, and 730 and the origin. Therefore, the reflection (or reflectance) at the end of the stack is the magnitude of the vector 740 between the origin and point 730. Note that the reflection is substantially zero at a wavelength of incident light 150 of about 550 nanometers. However, at a wavelength of incident light 150 of about 370 nanometers and about 700 nanometers the reflections are different from each other and from the substantially zero reflection at about 550 nanometers. This is in agreement with the behavior of plot 300 of FIG. 3 that illustrates that the reflection depends on the wavelength of the incident light.

In FIGS. 8A-8C, point 802 corresponds to the surface of total reflector 102 of micro-display 100 of FIG. 1, and point 804 corresponds to lower surface 157 of partially reflective layer 108 adjacent an interface between gap 106 and partially reflective layer 108 (FIG. 1). Point 806 corresponds to interface 155 between compensator layer 110 and partially reflective layer 108 (FIG. 1). Point 810 corresponds to interface 153 between compensator layer 112 and compensator layer 110 (FIG. 1), and point 820 corresponds to interface 151 between transparent stiffening layer 114 and compensator layer 112 (FIG. 1) and denotes the end of the stack for which FIGS. 8A-8C correspond. Note that the curves between point 806 and point 820 represent the effect of compensator 109. It is seen that compensator 109 compensates for the effect of wavelength of incident light on the reflectance (or the black state) in that the reflection at point 820 is substantially zero at each of the wavelengths incident light 150, as the distance between point 820 and the origin at each of the wavelengths is substantially zero. Therefore, the black state is essentially independent of the color of the incident light, and compensator 109 acts improve the broadband black state performance of a device across the visible spectrum (e.g., roughly 380 nm to 700 nm).

FIGS. 8A-8C also show that the reflection (or reflectance) is fairly uniform between points 802 and 804 within gap 106 of FIG. 1. The reflection is reduced between points 804 and 806 within partially reflective layer 108. Between points 806 and 820, compensator 109 of FIG. 1 reduces the reflection to substantially zero at point 820 across the visible spectrum. That is, compensator 109 acts to substantially extinguish the reflection across the visible spectrum. Note that similar behavior occurs for light-absorbing, anti reflective stack 200 of FIG. 2, where dielectric layer 220 replaces gap 106.

The absorption of incident radiation (or alternatively extinction of the electric field) by partially reflective layer 108 determines an allowable thickness, such as the maximum allowable thickness, of partially reflective layer 108. Effectively the greater the absorption, the less light enters and escapes the device, and thus the modulator acts more like a mirror than a tunable modulator. At high thicknesses of partially reflective layer 108 (e.g., greater than skin depth), the radiation is unaffected by gap 106 (e.g., Fabry Perot cavity), and the reflected spectra is the native reflectance of partially reflective layer 108. At low thicknesses of partially reflective layer 108 (e.g., less than skin depth), the device tunes color states well, but a poor black state results. At proper thicknesses of partially reflective layer 108, the device maintains wavelength tunability with the ability to absorb the bulk of the incident light in the black state.

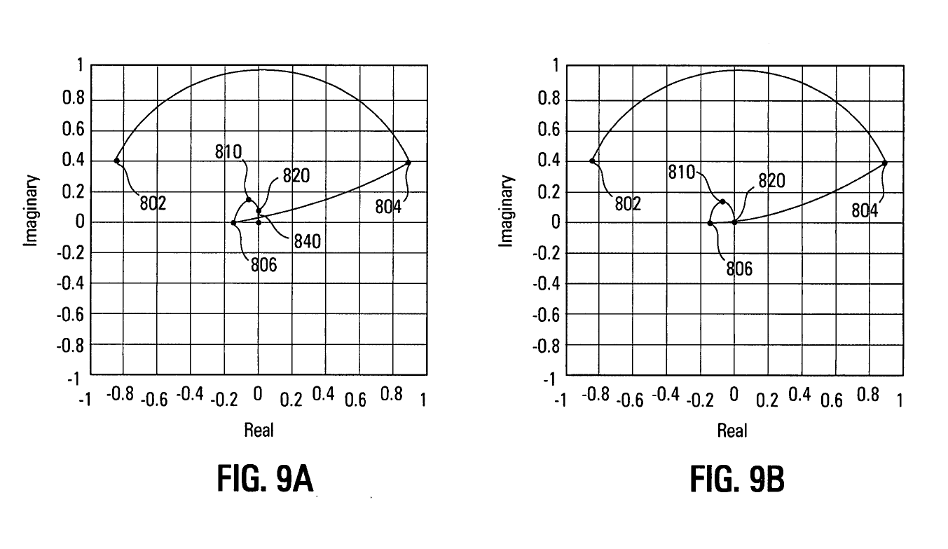

The behavior described above regarding performance as a function of the thickness of partially reflective layer 108 is modified by the addition of compensator 109 in the thin film stack. Compensator 109 allows for increased film variability by decreasing performance sensitivity to phase; e.g., to account for manufacturing variability. This effect is illustrated in FIGS. 9A and 9B, according to another embodiment.

FIGS. 9A and 9B are reflection diagrams and are similar in construction to FIGS. 8A-8C. The intensity of reflection is represented by the magnitude of a vector 840 between the origin and point 820 in FIGS. 9A and 9B. In FIG. 9A, vector 840 corresponds to the reflection for a device with an error in the thickness of partially reflective layer 108 (FIG. 1). In FIG. 9B vector 840 corresponds to the reflection for a device with the error in the thickness of partially reflective layer 108 corrected by compensator 109 (FIG. 1) to account for the error. Compensator 109 decreases the magnitude of vector 740, thereby accounting for the manufacturing error and thus improving the black state performance.

Note that the effect of compensator 109 on the performance of light-absorbing, anti reflective stack 200 of FIG. 2 is similar to that described above in conjunction with FIGS. 8A-8C and 9A-9B for the structure of FIG. 1.

Compensator 109 acts to improve the broadband black state performance of the device, as well as decreasing the sensitivity to manufacturing variation. This makes the device more practical to fabricate. Compensator 109 adjusts for the broadband admittance mismatch that would have occurred in it's absence at the dielectric/metal interface 104 to 108 using combination of high-index (e.g., an index of refraction of about 2.02) and low index (e.g., an index of refraction of about 1.46) materials or dielectric and non-dielectric (absorbing) materials. Compensator 109 improves manufacturability by decreasing effect of slight errors in deposition thickness of partially reflective layer 108. Compensator 109 relies upon combination of dielectric and non-dielectric (metal) layers for performance. Exemplary material sets include but are not limited to: SiC, SiO₂, TaAl, and air; SiN, SiO₂, TaAl, and air.

### CONCLUSION

Although specific embodiments have been illustrated and described herein it is manifestly intended that the scope of the claimed subject matter be limited only by the following claims and equivalents thereof.

What is claimed is:

1. A light absorbing, anti-reflecting filter comprising:
a total reflective layer;
a dielectric layer formed on the total reflective layer;
a partially reflective layer formed on the dielectric layer;
a first compensator layer formed on the first partially reflective layer; and
a second compensator layer formed on the first compensator layer;
wherein the first and second compensator layers have different indicies of refraction.

2. The light absorbing, anti-reflecting filter of claim 1, wherein the partially reflective layer is selected from the group consisting of metal layers and layers formed from alloys of tantalum and aluminum.

3. The light absorbing, anti-reflecting filter of claim 1, wherein the first compensator layer is an oxide.

4. The light absorbing, anti-reflecting filter of claim 3, wherein the second compensator layer is selected from the group consisting of nitride, carbide, a partially reflecting material, and tantalum-aluminum.

5. The light absorbing, anti-reflecting filter of claim 1 further comprises a transparent stiffening layer disposed on the second compensator layer.

6. The light absorbing, anti-reflecting filter of claim 1, wherein a reflectance at the second compensator layer is substantially independent of wavelength of light incident on the filter.

7. The light absorbing, anti-reflecting filter of claim 1, wherein the dielectric layer is an oxide.

8. The light absorbing, anti-reflecting filter of claim 1, wherein the second compensator layer has a greater index of refraction than the first compensator layer.

9. The light absorbing, anti-reflecting filter of claim 1, wherein the partially reflective layer is a first partially reflective layer and the dielectric layer is a first dielectric layer, and further comprising:
a second dielectric layer formed on the total reflective layer opposite the first dielectric layer; and
a second partially reflective layer formed on the second dielectric layer.

10. The light absorbing, anti-reflecting filter of claim 1, wherein the partially reflective layer is a first partially reflective layer and the dielectric layer is a first dielectric layer, and further comprising:
a second dielectric layer formed on the total reflective layer opposite the first dielectric layer;
a second partially reflective layer formed on the second dielectric layer;
a third compensator layer formed on the second partially reflective layer; and
a fourth compensator layer formed on the third compensator layer, and having an index of refraction that is different from the third compensator layer.

11. The light absorbing, anti-reflecting filter of claim 10, wherein the fourth compensator layer has a greater index of refraction than the third compensator layer.

12. The light absorbing, anti-reflecting filter of claim 10, wherein the second and fourth compensators layers are of substantially the same materials.

13. The light absorbing, anti-reflecting filter of claim 10, wherein the first and third compensator layers are of substantially the same materials.

14. A micro-display comprising:
one or more total reflectors separated from a partially reflective layer by a selectively adjustable gap;
a first compensator layer overlying the partially reflective layer; and
a second compensator layer overlying the first compensator layer, and having a greater index of refraction than the first compensator layer;
wherein when the gap is adjusted to produce an OFF or light absorbing state of the micro-display, the first and second compensator layers cause a reflectance of the micro-display to be substantially independent of wavelength of light incident on the micro-display.

15. The micro-display of claim 14, wherein the adjustable gap is a vacuum, air, or an inert gas.

16. The micro-display of claim 14 further comprises a transparent stiffening layer overlying the second compensator layer.

17. The micro-display of claim 14, wherein each of the one or more total reflectors corresponds to one or more pixels of an array of pixels of the micro-display.

18. The micro-display of claim 14, wherein the second compensator layer is selected from the group consisting of nitride and carbide.

19. The micro-display of claim 18, wherein the first compensator layer is an oxide layer.

20. A micro-display comprising:
a plurality of total reflectors;
a plurality of stacks, each stack separated from a respective one of the total reflectors by a selectively adjustable gap, each of the stacks comprising:
a partially reflective layer overlying one of the adjustable gaps;
a first compensator layer overlying the partially reflective layer; and
a second compensator layer overlying the first dielectric layer, and having a greater index of refraction than the first compensator layer;
wherein when that adjustable gap is adjusted to produce an OFF state of the micro-display, the first and second compensators layers cause a reflectance of the micro-display to be substantially independent of wavelength of light incident on the micro-display;
a transparent stiffening layer having a first portion overlying the second compensator layer; and
a light absorbing, anti-reflective filter overlying a second portion of the transparent stiffening layer that is located between adjacent stacks.

21. The micro-display of claim 20, wherein the partially reflective layer of a stack is a first partially reflective layer and each of the plurality of total reflectors is a first total reflector, and wherein the light absorbing, anti-reflective filter comprises:
a second total reflector formed on the second portion of the transparent stiffening layer;
a dielectric layer formed on the second total reflector;
a second partially reflective layer formed on the dielectric layer;
a third compensator layer formed on the second partially reflective layer; and
a fourth compensator layer formed on the third compensator layer.

22. The micro-display of claim 21, wherein the fourth compensator layer has a greater index of refraction than the third compensator layer.

23. The micro-display of claim 21, wherein the first portion of the transparent stiffening layer overlies the fourth compensator layer.

24. The micro-display of claim 20, wherein the partially reflective layer of a stack is a first partially reflective layer and each of the plurality of total reflectors is a first total reflector, and wherein the light absorbing, anti-reflective filter comprises:
a second partially reflective layer formed on the second portion of the transparent stiffening layer;
a first dielectric layer formed on the second partially reflective layer;
a second total reflector formed on the first dielectric layer;
a second dielectric layer formed on the second total reflector;
a third partially reflective layer formed on the second dielectric layer;
a third compensator layer formed on the third partially reflective layer; and
a fourth compensator layer formed on the third compensator layer.

25. The micro-display of claim 24, wherein the fourth compensator layer has a greater index of refraction than the third compensator layer.

26. The micro-display of claim 24, wherein the first portion of the transparent stiffening layer overlies the fourth compensator layer.

27. The micro-display of claim 20, wherein the partially reflective layer of a stack is a first partially reflective layer and each of the plurality of total reflectors is a first total reflector, and wherein the light absorbing, anti-reflective filter comprises:
a third compensator layer formed on the second portion of the transparent stiffening layer;
a fourth compensator layer formed on the third compensator layer;
a second partially reflective layer formed on the fourth compensator layer;
a first dielectric layer formed on the third partially reflective layer;
a second total reflector formed on the first dielectric layer;
a second dielectric layer formed on the second total reflector;
a third partially reflective layer formed on the second dielectric layer;
a fifth compensator layer formed on the third partially reflective layer; and
a sixth compensator layer formed on the fifth compensator layer.

28. The micro-display of claim 27, wherein the third compensator layer has a greater index of refraction than the fourth compensator layer.

29. The micro-display of claim 28, wherein the sixth compensator layer has a greater index of refraction than the fifth compensator layer.

30. The micro-display of claim 27, wherein the first portion of the transparent stiffening layer overlies the sixth compensator layer.

31. The filter of claim 27, wherein the third and sixth compensator layers are of substantially the same material.

32. The filter of claim 31, wherein the fourth and fifth compensators layers are of substantially the same material.

33. The micro-display of claim 20, wherein the filter is aligned with a region between adjacent total reflectors.

34. A fabrication method comprising:
forming a first compensator layer on a partially reflective layer; and
forming second compensator layer on the first compensator layer;
wherein forming the first and second compensator layers comprises adjusting a thickness of the first compensator layer or the thickness of the second compensator layer or both if a thickness of the partially reflective layer is determined to be in error.

35. The fabrication method of claim 34, wherein adjusting a thickness of the first compensator layer or the thickness of the second compensator layer or both compensates for an effect of the error on reflections at a surface of the second compensator layer.

36. The fabrication method of claim 34, wherein the partially reflective layer and the first and second compensator layers form a portion of a micro-display or a filter.

37. The fabrication method of claim 34 further comprises separating a total reflector from the partially reflective layer with a selectively adjustable gap.

38. The fabrication method of claim 34 further comprises separating a total reflector from the partially reflective layer with a first dielectric layer.

39. The fabrication method of claim 34 further comprises forming a stiffening layer on the second compensator layer.

40. The fabrication method of claim 34, wherein the second compensator layer has a greater index of refraction than the first compensator layer.

41. A method of operating a micro-display, comprising:
reflecting incident light off a total reflector;
passing the reflected light through a dielectric material;
passing the reflected light through a partially reflecting layer to reduce an intensity of the reflected light to a first intensity; and
passing the light at the first intensity through a compensator to reduce the first intensity to a second intensity that is substantially zero regardless of a wavelength of the incident light.

42. The method of claim 41, wherein passing the reflected light through a dielectric material comprises passing the reflected light through an adjustable air gap.

43. The method of claim 41, wherein passing the reflected light through a dielectric material comprises passing the reflected light through a layer of solid dielectric material.

44. The method of claim 41, wherein the incident light is generated exteriorly of the micro-display or reflected from an interior of the micro-display.

45. The method of claim 41, wherein the compensator comprises first and second compensator layers, the second compensator layer having a greater index of refraction than the first compensator layer, the first compensator layer interposed between the dielectric material and the second compensator layer.

46. A micro-display comprising:
a means for reducing an intensity of incident light to a first intensity; and
a means for reducing the first intensity to a second intensity that is substantially zero irrespective of a wavelength of the incident light.

47. The micro-display of claim 46, wherein the incident light is generated exteriorly of the micro-display or reflected from an interior of the micro-display.

48. A micro-display comprising:
a plurality of pixels;
a light absorbing, anti-reflective filter overlying the plurality of pixels, the light absorbing, anti-reflective filter comprising:
a total reflective layer;
a dielectric layer formed on the total reflective layer;
a partially reflective layer formed on the dielectric layer;
a first compensator layer formed on the first partially reflective layer; and
a second compensator layer formed on the first compensator layer;
wherein the first and second compensator layers have different indicies of refraction.

49. The micro-display of claim 48, wherein the partially reflective layer is a first partially reflective layer and the dielectric layer is a first dielectric layer, and further comprising:
a second dielectric layer formed on the total reflective layer opposite the first dielectric layer; and
a second partially reflective layer formed on the second dielectric layer.

50. The micro-display of claim 48, wherein the partially reflective layer is a first partially reflective layer and the dielectric layer is a first dielectric layer, and further comprising:
a second dielectric layer formed on the total reflective layer opposite the first dielectric layer;
a second partially reflective layer formed on the second dielectric layer;
a third compensator layer formed on the second partially reflective layer; and
a fourth compensator layer formed on the third compensator layer, and having an index of refraction that is different from the third compensator layer.

51. The micro-display of claim 50, wherein the fourth compensator layer has a greater index of refraction than the third compensator layer.

52. The micro-display of claim 50, wherein the second and fourth compensators layers are of substantially the same materials.

53. The micro-display of claim 50, wherein the first and third compensator layers are of substantially the same materials.
